(19) United States
(12) Patent Application Publication
(10) Pub. No.: US 2015/0130592 A1
(43) Pub. Date: May 14, 2015

(54) PACKAGE-LOADING SYSTEM

(71) Applicant: SYMBOL TECHNOLOGIES. INC., Lincolnshire, IL (US)

(72) Inventors: KARTHIK LAKSHMINARAYANAN, WILMINGTON, DE (US); MICHAEL E. GROBLE, LAKE ZURICH, IL (US); KEVIN J. O'CONNELL, PALATINE, IL (US); CUNEYT M. TASKIRAN, CHICAGO, IL (US); JAY J. WILLIAMS, GLENVIEW, IL (US)

(21) Appl. No.: 14/079,093

(22) Filed: Nov. 13, 2013

(51) Int. Cl. B65G 65/00; G06K 7/10; B65G 67/04

(52) U.S. Cl. CPC B65G 65/005; B65G 67/04; G06K 7/10297
USPC 340/10.1

(57) ABSTRACT

An embodiment takes the form of a method carried out by a package-loading system. The system includes a processor and data storage containing instructions executable by the processor for carrying out the method. The method includes identifying a current package to be loaded by a user into a cargo container, and determining a target position in the cargo container for placement by the user of the identified current package. The method further includes providing for the user a visual indication of the determined target position.

### BACKGROUND OF THE INVENTION

A problem frequently encountered in the transportation and logistics industry is inefficient use of available space in cargo containers. For any given logistics provider, container utilization may average as low as 70%, or perhaps even lower. This underutilization of container space typically results in increased operational costs and decreased revenue for the logistics provider, as well as unnecessarily delayed deliveries, which negatively affects both the logistics provider and their customers. And certainly this underutilization causes other problems as well.

One factor that contributes to inefficient container utilization is inexperience of the individuals loading the cargo into the container. The task of loading cargo is both physically and mentally exhausting: loaders are tasked with maximizing container utilization while loading packages in a relatively small amount of time. These demands, among others, tend to result in comparatively high turnover rates. Newly hired loaders often receive inadequate training, and onsite supervisors are often unable to provide adequate guidance to new loaders. These factors, among others, led the inventors to identify a need for an improved package-loading system.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example of an underutilized cargo container.

FIGS. 2 and 3 illustrate an example operation of a package-loading system, in accordance with some embodiments.

FIG. 4 is a simplified block diagram of a package-loading system, in accordance with some embodiments.

FIG. 5 is a flowchart of a method, in accordance with some embodiments.

FIG. 6 illustrates a respective representation along a sight line between a user and a determined target position, in accordance with some embodiments

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

An embodiment takes the form of a method carried out by a package-loading system. The system includes a processor and data storage containing instructions executable by the processor for carrying out the method. The method includes identifying a current package to be loaded by a user into a cargo container, determining a target position in the cargo container for placement by the user of the identified current package, and providing for the user a visual indication of the determined target position.

### I. INTRODUCTION

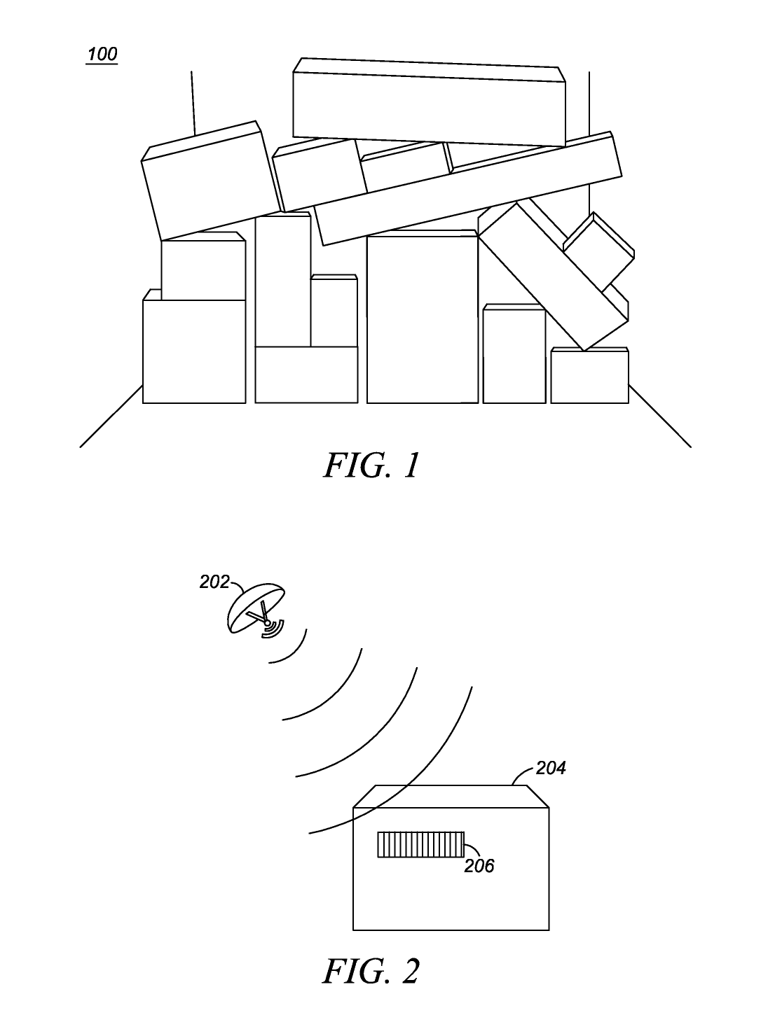

FIG. 1 depicts an example of an underutilized cargo container, where the underutilization occurs as a result of improper package loading. As shown, many of the packages in cargo container 100 are positioned in a manner that leaves significant wasted space between and among adjacent packages. Unless smaller packages can be positioned within these spaces, the overall space will remain underutilized; and even if smaller packages can be positioned within those open spaces between and among the depicted packages, it is quite unlikely that those smaller packages will happen to have shapes and sizes that efficiently occupy those interstitial three-dimensional gaps. Providing guidance to a loader when positioning packages in the cargo container would tend to result in less open space being left between and among adjacent packages, and would thus tend to increase the utilization of the available space in the container.

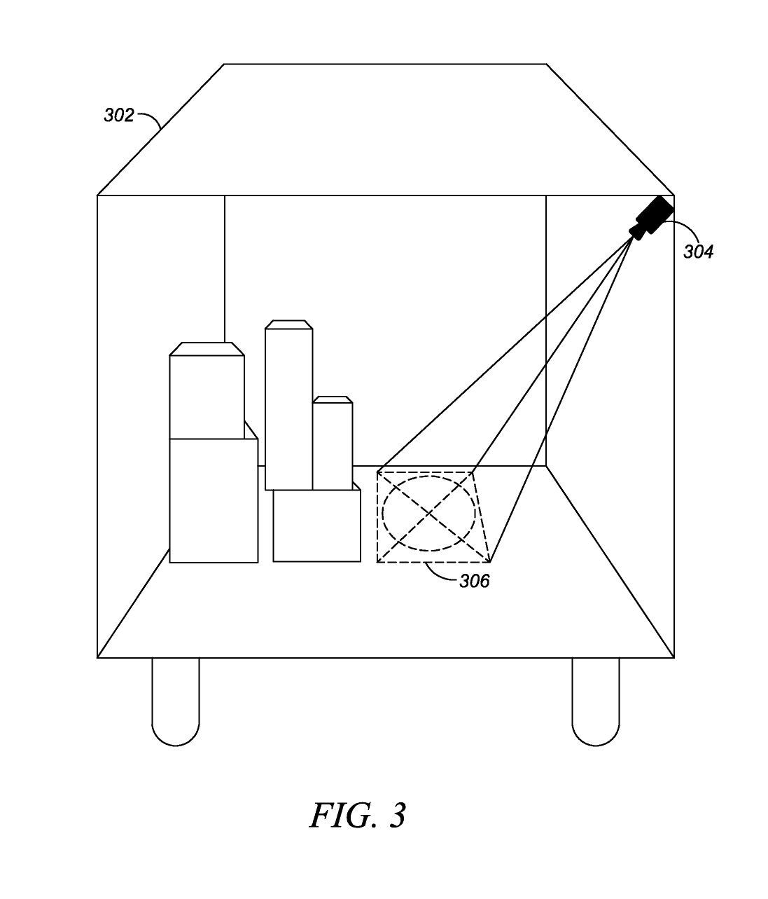

FIGS. 2 and 3 illustrate an example operation of an example package-loading system, in accordance with some embodiments. In the embodiment that is illustrated in FIGS. 2 and 3, a package-loading system uses a radio-frequency identification (RFID) scanner 202 to obtain an encoded identifier from an RFID tag 206 affixed to a package 204 to be positioned by a loader in a cargo container 302. The system queries a server using the obtained identifier and receives from the server a set of characteristics of package 204. The characteristics might include package weight, dimensions, and/or any other one or more package characteristics deemed suitable by one of skill in the art for a given context. Using the received set of characteristics of package 204, the system determines a target position in the cargo container for placement by the loader of package 206. As illustrated in FIG. 3, in the depicted embodiment, the package-loading system uses a projector 304 to provide for the loader a visual indication 306 of the determined target position.

These as well as other aspects, advantages, and alternatives will become apparent to those of ordinary skill in the art by reading the following detailed description with reference where appropriate to the accompanying drawings. Further, it should be understood that the description provided in this section and elsewhere in this document is intended to illustrate the claimed subject matter by way of example and not by way of limitation.

### II. EXAMPLE PACKAGE-LOADING SYSTEM

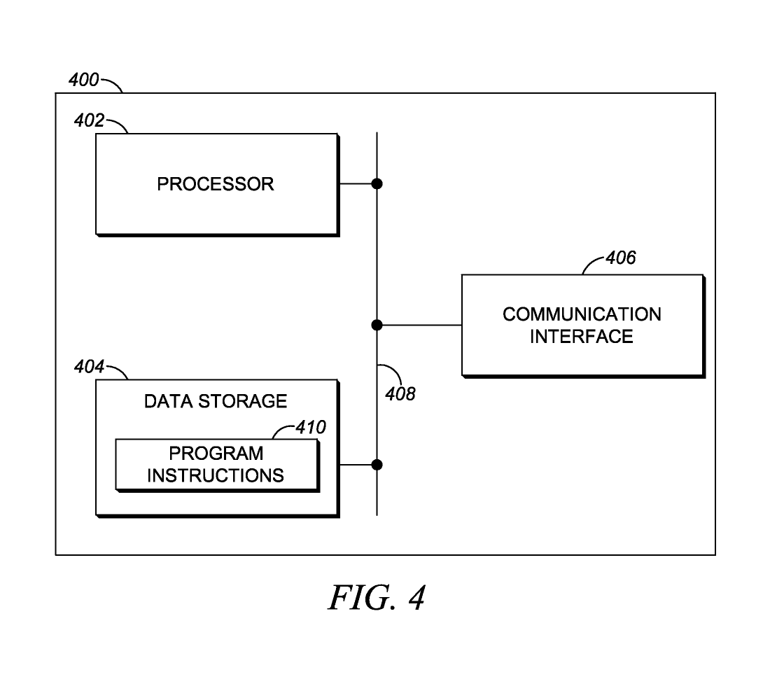

FIG. 4 is a simplified block diagram of a package-loading system, in accordance with some embodiments. In the embodiment that is illustrated in FIG. 4, package-loading system 400 includes a processor 402, a non-transitory data storage 404, and a communication interface 406, each of which are interconnected via a system bus or other communication mechanism 408. The package-loading system could include additional and/or different components not illustrated in FIG. 4, and may not necessarily include all of the illustrated components.

Processor 402 may take the form of (or include) one or more general-purpose processors and/or one or more special-purpose processors, and may be integrated in whole or in part with data storage 404 and/or communication interface 406. Processor 402 could take other forms as well.

Data storage 404 may store program instructions 410, package characteristics, and/or user-interface data, among numerous other possibilities. The data storage may take the form of (or include) a non-transitory computer-readable medium such as a hard drive, a solid-state drive, an EPROM, a USB storage device, a CD-ROM disk, a DVD disk, any other non-volatile storage, or any combination of these, to name just a few examples. Program instructions 410 may include machine-language instructions executable by processor 404 to carry out various functions described herein. The data storage and/or program instructions could take other forms as well.

Communication interface 406 may be any component capable of performing the communication-interface functions described herein. The communication interface could take the form of (or include) an Ethernet, Wi-Fi, Bluetooth, and/or universal serial bus (USB) interface, and/or a system bus, among other examples. The communication interface could facilitate communication among components within package-loading system 400 and/or with other entities communicatively connected to the package-loading system, among other possibilities. For example, the package-loading system might be communicatively connected to a computer monitor, a server, a barcode scanner, a range camera, a liquid crystal display (LCD) projector, and/or or near-eye display, among many other examples, and the communication interface might facilitate communication between the package loading system and these entities. Those having skill in the art will recognize that communication interface 406 and/or system bus 408 could take other forms as well.

### III. EXAMPLE METHOD

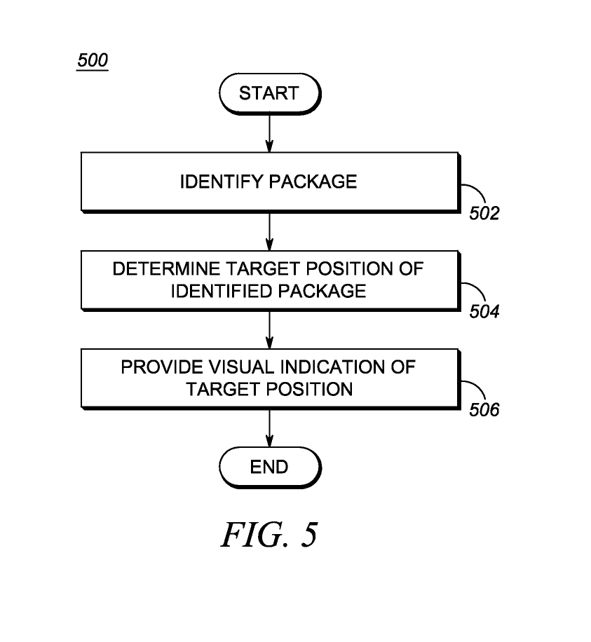

FIG. 5 is a flowchart of a method, in accordance with some embodiments. As shown, method 500 begins at step 502 with package-loading system 400 identifying a current package to be loaded by a user into a cargo container.

Identifying the current package could include using, for example, a range camera and/or a structured-light 3D scanner to obtain a characteristic of the current package. The characteristic could be the dimensions (e.g., a height, width, and depth) of the current package, a type (e.g., a corrugated box, a steel, drum, etc.) of the current package, and/or a weight of the current package (perhaps by estimating the weight using the package dimensions and package type), among numerous other possibilities.

Additionally or alternatively, identifying the current package could include obtaining an identifier of the current package. The identifier could take the form of (or include) an encoded identifier provided by an identification (ID) tag such as a barcode, a QR code, a radio-frequency identification tag, a near field communication (NFC) tag, a proximity card, any other ID tag, or any combination of these, as just a few examples. The ID tag could be located on a surface of the package (on, e.g., a sticker attached to an outer surface of the package), and/or could be present within the package (perhaps on or in a device such as an RFID tag), among other possibilities.

Obtaining the identifier of the current package could include obtaining the identifier using a package-identity detector such as an optical scanner (such as a barcode scanner or a QR-code scanner, among other possibilities), an RFID scanner, an NFC scanner, a proximity card scanner, any other package-identity detector, or any combination of these, among many other possibilities. Obtaining the identifier of the current package could take other forms as well.

In an embodiment, identifying the current package involves identifying a package that is in proximity to the user as being the current package. As an example, the package-identity detector could include a stereo ranging camera. The package-loading system may use the stereo ranging camera to detect objects within an area viewable by the camera, as well as to obtain depth information for those objects. The system may classify one of the objects as a person and one or more of the other objects as packages. Of the package-classified objects, the object having depth information that is the most similar to that of the person-classified object could be identified as the current package. Other variations are possible as well.

In an embodiment, identifying the current package involves identifying a package that is in proximity to the package-identity detector as being the current package. As an example, the package-identity detector could include a handheld detector. Identifying the package in proximity to the package-identity detector as the current package could include identifying a package, the identifier of which was obtained using the handheld detector, as being the current package. If the handheld detector is unable to obtain an identifier that is no more than a few inches away, then deliberate action on the part of the user may be helpful in obtaining the identifier. Accordingly, the package loading system can interpret as the current package (with reasonable certainty) the package of which the identifier was obtained using the handheld detector. Other variations are possible as well.

The cargo container could be any type of container capable of being loaded with packages. As examples, the cargo container could take the form of (or include) a truck trailer, a semi-trailer, a cargo area of an aircraft (such as a passenger aircraft or a cargo aircraft, as examples), a cargo ship, a railroad car, a freight car, a boxcar, an intermodal freight container, any other cargo container, or any combination of these, as examples. The cargo container could be an enclosed (or partially-enclosed) container (as may be the case for a semi-trailer), and/or could be an open container (as may be the case for a railroad flatcar). The cargo container could take on one or more of a variety of shapes.

The current package could be any type of package capable of being loaded into the cargo container. As examples, the current package could take the form of (or include) a corrugated box, a wooden box, a bulk box, a crate, a pallet, a drum, a pail, a unit load device, an insulated shipping container, an intermediate bulk shipping container, any other package, or any combination of these, as just a few possibilities. The package could be an intermodal freight container, perhaps loaded into a cargo ship or an aircraft. The package could have one or more of a variety of shapes, such as a cube, a cuboid, and/or a cylinder, among many other possibilities.

At step 504, package-loading system 400 determines a target position in the cargo container for placement by the user of the identified current package. Determining the target position could include applying one or more characteristics of the current package to a package-loading model. As examples, the package-loading model could take the form of (or include) one or more of the models described in Teodor Gabriel Crainic et al., Recent Advances in Multi-Dimensional Packing Problems, New Technologies: Trends, Innovations and Research, at 91-110 (2012); Wissam F. Maarouf et al., A New Heuristic Algorithm for the 3D Bin Packing Problem, Innovations and Advanced Techniques in Systems, Computing Sciences and Software Engineering, at 342-45 (2008); Andrea Lodi et al., Heuristic Algorithms for the Three-Dimensional Bin Packing Problem, 141 European Journal of Operational Research 410-20 (2002); Silvano Martello et al., The Three-Dimensional Bin Packing Problem (May 1997), website at citeseerx.ist.psu.edu/viewdoc/summary?doi=10.1.1.27.8658; and Bagor Balambos & Gerhard Woeginer, On-Line Bin Packing: A Restricted Survey, 42 Mathematical Methods of Operations Research 25-45 (1995), the entire contents of each which are hereby incorporated by reference. The package-loading model could take other forms as well.

In an embodiment, identifying the current package includes obtaining an identifier of the current package, and determining the target position includes determining the target position using the obtained identifier. Determining the target position using the obtained identifier could include querying a server with the obtained identifier and receiving from the server an indication of the target position. The server may obtain a set of characteristics of the current package, perhaps by searching a data storage of the server and/or by querying a relational database management system (RDBMS). The server may then apply those characteristics to a package-loading model to obtain the target position, and may send to the package-loading system an indication of the obtained target position. Other variations are possible as well.

As another possibility, determining the target position using the obtained identifier could include querying the server with the obtained identifier, receiving from the server a set of characteristics of the current package, and using the received set of characteristics to determine the target position. The server could take the form of (or include) an RDBMS, among other possibilities. The package loading system may determine the target position by applying the received set of characteristics to a package-loading model to obtain the target position. Determining the target position using the obtained identifier could take other forms as well.

Determining the target position could include determining the target position based on respective positions of one or more packages already loaded into the cargo container. For example, the package-loading system may apply the positions of the already-loaded packages (including incorrectly-loaded packages) to a package-loading model (perhaps in addition to applying characteristics of the current package).

In an embodiment, the package-loading system receives data indicative of the respective positions of the one or more already-loaded packages. For example, the package-loading system may query a server (such as an RDBMS) to obtain data indicative of the respective positions of the already-loaded packages. The package-loading system may receive from the server a set of one or more characteristics of the already-loaded packages, the set including the data indicative of the respective positions of the already-loaded packages. In various embodiments, the computing system obtains the respective positions of the one or more already-loaded packages using a range camera, a structured-light 3D scanner, a light detection and ranging (LIDAR) system, a radio detection and ranging (RADAR) system, a sound navigation and ranging (SONAR) system, any other device configured to obtain respective positions of the already-loaded packages, or any combination of these, as just a few examples. Other variations are possible as well.

At step 506, package-loading system 400 provides for the user a visual indication of the determined target position. Providing the visual indication could include providing the indication via a user interface—e.g., by providing the indication to a user interface for presentation to the user. The user interface could take the form of (or include) an image projector and/or a video display (as described below), as just a couple of possibilities. The user interface could further (or alternatively) include a loudspeaker, a microphone, a haptic actuator, and/or a light sensor, among other examples. In addition to (or instead of) providing the visual indication, the package-loading system could provide an audible (or other) indication via the user interface. The audible indication could include (or take the form of) a spoken indication of the location, as just one example. The user interface could be incorporated with other entities such as a package-identity detector (e.g., RFID scanner 202) and/or a package-location detector (such as projector), among other possibilities. Providing the indication via the user interface could take other forms as well.

Providing the visual indication could include projecting the visual indication on to the cargo container, which in turn could involve projecting the indication using an image projector, a laser projector, a light emitting diode (LED) projector, a liquid crystal display (LCD) projector, any other device configured to project the visual indication, or any combination of these, as examples. As one example, a projector could be mounted to an X-Y assembly, and the assembly could be attached (permanently or temporarily) to the cargo container. Projecting the visual indication could take other forms as well.

Providing the visual indication could include presenting the visual indication on a video display. The video display could take the form of (or include) a near-eye display, a head-mounted display, a mobile computer, a handheld computer, a tablet computer, a smartphone, a personal digital assistant (PDA), a computer monitor, any other video display, or any combination of these, among other possibilities. Presenting the visual indication on the video display could include presenting respective representations of both the cargo container and the visual indication of the determined target position. Other variations are possible as well.

Presenting respective representations of both the cargo container and the visual indication of the determined target position could include presenting at least one of the respective representations along a sight line between the user and the determined target position. In some embodiments, the technology known in the art as “augmented reality” could be employed to depict for the user the visual indication of the determined target position for the package in (or on, or on to, etc.) the cargo container.

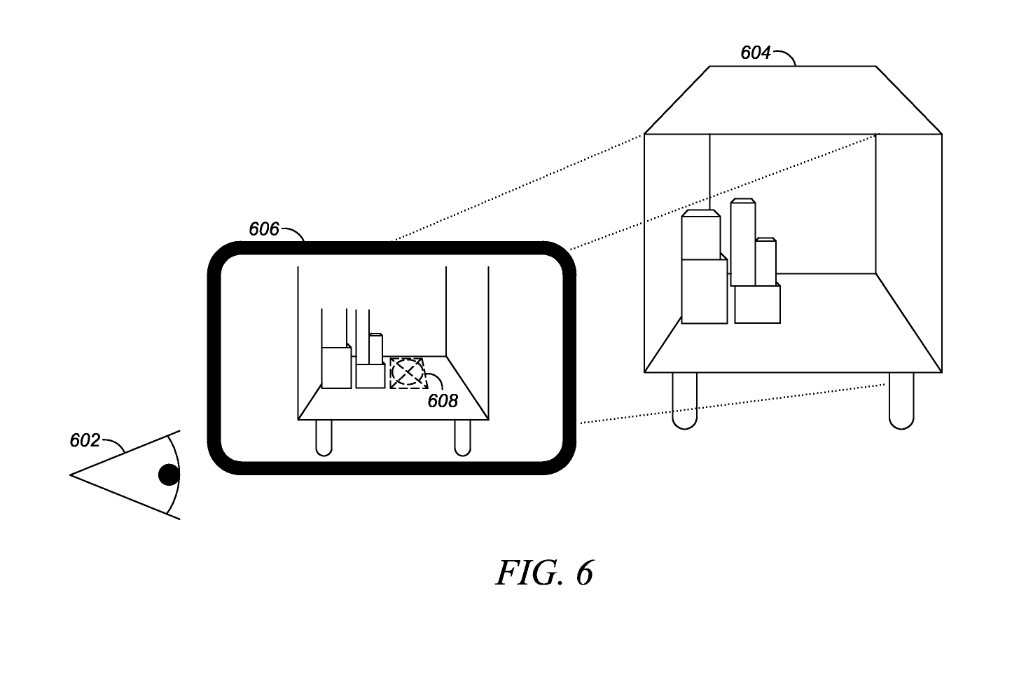

FIG. 6 illustrates a respective representation along a sight line between a user and a determined target position, in accordance with some embodiments. As shown, the visual display is part of a tablet device 606 that also includes a front-facing video camera. The computing system presents, via tablet device 606, an image of cargo container 604 as taken by the video camera. Further, the image of cargo container 604 is overlaid with representation 608—that is, a representation of the visual indication of the determined target position. As illustrated, the visual indication appears to user 602 of tablet device 606 as being located at the determined target position (as if the visual indication had actually been captured by the front-facing video camera). As tablet device 606 moves and the displayed image changes, the computing system may relocate (i.e., re-depict and/or re-render) the representation of the visual indication of the determined target position so that the moved image is overlaid with the relocated representation again (or still) appearing to be at the determined target location. Those of skill in the art will appreciate that presenting the visual indication on the video display, including presenting respective representations of both the cargo container and the visual indication, could take other forms as well.

The visual indication could take the form of (or include) an arrow, a symbol, a two-dimensional representation of the package, a three-dimensional representation of the package, any other visual indication of the determined target position, or any combination of these, to name just a few possibilities. For example, an arrow could be projected on to the cargo container so as to appear to be pointing at or to the determined target position. The two-dimensional presentation of the package could take the form of (or include) a projected outline of one side of the current package, the outline indicating to the user that the package should be positioned at the location of the outline so that the side of the package presented as an outline is positioned within the projected outline. The visual indication could be of a given color, the color perhaps indicating to the user that the package should be placed at the determined target position in a manner associated with the given color. The visual indication could take other forms as well.

Furthermore, in some embodiments, the package-loading system is arranged to detect whether the loader has in fact successfully loaded the current package at the target position that the system had visually indicated to the loader. For example, the package-loading system might obtain, both before and after the current package is loaded, depth information of packages in the cargo container. The system may detect (perhaps using a range camera) that the user has entered and subsequently exited the container; upon so detecting, the system may obtain (and perhaps store) the depth information of packages then loaded in to the cargo container (perhaps again using a range camera). The package-loading system may obtain a loaded position of the current package based on a comparison of depth information obtained before and after the current package was loaded and, based on the loaded position, may determine whether the current package was loaded in to the cargo container at the determined target position. To determine that the package was loaded at the determined target position, the system could determine whether a difference between the obtained loaded position and the determined target position is within a threshold difference (a determination that the difference is within the threshold difference being a determination that the current package was loaded at the determined target position).

Upon determining that the current package was loaded in to the cargo container at the determined target position, the system may provide one or more confirmation indications to the user, perhaps via a user interface. For example, providing the alarm indication could include providing the indication to a user interface for presentation to the user. The confirmation indication could be a visual, audible, and/or tactile confirmation, perhaps indicating to the user that the package was loaded at the determined target location. Providing the confirmation indication could take other forms as well.

Upon determining that the current package was loaded in to the cargo container at a position other than the determined target position, the system may provide one or more alarm indications to the user, again perhaps via a user interface. The alarm indication could alert the user to the misplacement of the package, and may include instructions to the user for repositioning the loaded package to the determined target position. Providing the alarm indication could take other forms as well.

In some embodiments, the package-loading system is arranged to not proceed to assisting in placement of one or more subsequent packages until confirming successful placement of the current package. In some embodiments, the system is arranged to proceed to assisting in placement of one or more subsequent packages even without confirming successful placement of the current package. In some embodiments, the package-loading system is arranged to store and/or transmit reports regarding positions in the cargo container where one or more packages have been loaded, perhaps to aid the analysis regarding placement of one or more subsequent packages. And certainly other possibilities abound, as will be apparent to those having both skill in the relevant art and the benefit of this disclosure.

Those having skill in the art will appreciate that identifying the current package, determining the target position of the identified current package, and/or providing the visual indication of the determined target position could take other forms as well.

### IV. CONCLUSION

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “based on” and “using” are to be read as meaning “based on at least” and “using at least,” respectively, unless otherwise noted. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method carried out by a package-loading system comprising a processor and data storage containing instructions executable by the processor for carrying out the method, the method comprising:
identifying a current package to be loaded by a user into a cargo container;
determining a target position in the cargo container for placement by the user of the identified current package; and
providing for the user a visual indication of the determined target position.

2. The method of claim 1, wherein identifying the current package comprises obtaining an identifier of the current package.

3. The method of claim 2, wherein obtaining the identifier of the current package comprises obtaining the identifier using a package-identity detector selected from the group consisting of an optical scanner, a radio-frequency identification (RFID) scanner, a near field communication (NFC) scanner, and a proximity card scanner.

4. The method of claim 1, wherein identifying the current package comprises identifying a package that is in proximity to the user as being the current package.

5. The method of claim 1, wherein identifying the current package comprises identifying a package that is in proximity to a package-identity detector as being the current package.

6. The method of claim 1, wherein the current package is selected from the group consisting of a corrugated box, a wooden box, a bulk box, a crate, a pallet, a drum, a pail, a unit load device, an insulated shipping container, an intermediate bulk shipping container, and an intermodal freight container.

7. The method of claim 1, wherein identifying the current package comprises identifying at least one of dimensions of the current package, a type of the current package, and a weight of the package using at least in part one of a range camera, a light detection and ranging (LIDAR) system, a radio detection and ranging (RADAR) system, and a sound navigation and ranging (SONAR) system.

8. The method of claim 1, wherein identifying the current package comprises obtaining an identifier of the current package, wherein determining the target position comprises determining the target position using the obtained identifier.

9. The method of claim 8, wherein determining the target position using the obtained identifier comprises querying a server with the obtained identifier and receiving from the server an indication of the target position.

10. The method of claim 8, wherein determining the target position using the obtained identifier comprises querying a server with the obtained identifier, receiving from the server a set of characteristics of the current package, and using the received set of characteristics to determine the target position.

11. The method of claim 1, wherein determining the target position comprises determining the target position based on respective positions of one or more packages already loaded into the cargo container.

12. The method of claim 11, further comprising receiving data indicative of the respective positions of the one or more already-loaded packages.

13. The method of claim 11, further comprising obtaining the respective positions of the one or more already-loaded packages using at least one of a range camera, a light detection and ranging (LIDAR) system, a radio detection and ranging (RADAR) system, and a sound navigation and ranging (SONAR) system.

14. The method of claim 1, wherein providing the visual indication comprises projecting the visual indication on to the cargo container.

15. The method of claim 14, wherein projecting the visual indication comprises projecting the indication using an image projector, a laser projector, a light emitting diode (LED) projector, and a liquid crystal display (LCD) projector.

16. The method of claim 1, wherein providing the visual indication comprises presenting the visual indication on a video display.

17. The method of claim 16, wherein presenting the visual indication on the video display comprises presenting respective representations of both the cargo container and the visual indication of the determined target position.

18. The method of claim 17, wherein presenting respective representations of both the cargo container and the visual indication of the determined target position comprises presenting at least one of the respective representations along a sight line between the user and the determined target position.

19. The method of claim 1, further comprising:
subsequent to providing the visual indication of the determined target position, determining whether the current package was loaded in to the cargo container at the determined target position;
in response to determining that the current package was loaded in to the cargo container at the determined target position, providing a confirmation indication to the user; and
in response to determining that the current package was loaded in to the cargo container at a position other than the determined target position, providing an alarm indication to the user.

20. A package-loading system comprising:
a processor; and
non-transitory data storage containing instructions executable by the processor for carrying out a set of functions, the set of functions comprising:
identifying a current package to be loaded by a user into a cargo container;
determining a target position in the cargo container for placement by the user of the identified current package; and
providing for the user a visual indication of the determined target position.
